(19) United States
(12) Patent Application Publication
(10) Pub. No.: US 2020/0084060 A1
(43) Pub. Date: Mar. 12, 2020

(54) METHOD OF CONTROLLING IOT DEVICE USING CLOUD PLATFORM, CLOUD SERVER AND SYSTEM FOR CONTROLLING IOT DEVICE

(71) Applicant: WIZnet Co., LTD., Seongnam-si (KR)

(72) Inventors: Bo Hyun Bang, Seongnam-si (KR); Bong Jun Hur, Suwon-si (KR); Hyuk Joo Kweon, Seongnam-si (KR); Young In Kim, Seongnam-si (KR)

(73) Assignee: WIZnet Co., LTD., Seongnam-si (KR)

(21) Appl. No.: 16/547,572

(22) Filed: Aug. 22, 2019

(30) Foreign Application Priority Data
Sep. 11, 2018 (KR) 10-2018-0108051

(51) Int. Cl. H04L 12/28; H04L 29/08

(52) U.S. Cl. CPC H04L 12/282; H04L 12/281; H04L 12/2814; H04L 67/125

(57) ABSTRACT

Disclosed are a method of controlling an IOT device using a cloud platform, a cloud server and a system for controlling an IOT device, including receiving a device identifier (ID) extracted from an image code recognized by a mobile terminal, determining an IOT device corresponding to the received device ID among a plurality of IOT devices capable of being connected to a wide area network, recognizing one or more state items and one or more control items corresponding to the determined IOT device, and transmitting state information, including one or more state items of the determined IOT device and control state information including one or more control items capable of controlling the determined IOT device and indicative of a current control state, to the mobile terminal.

### CROSS REFERENCE TO RELATED APPLICATION

This application is based on and claims priority under 35 U.S.C. 119 to Korean Patent Application No. 10-2018-0108051, filed on Sep. 11, 2018, in the Korean Intellectual Property Office, the disclosures of which is herein incorporated by reference in their entireties.

### BACKGROUND OF THE INVENTION

### 1. Technical Field

The present invention relates to a method of controlling an IOT device using a cloud platform, a cloud server and a system for controlling an IOT device and, more particularly, to a method of controlling an IOT device using a cloud platform, a cloud server and a system for controlling an IOT device, wherein the state of an IOT device recognized through an image code is identified using a cloud platform and the output of the IOT device is dynamically controlled.

### 2. Description of the Related Art

As the Internet technology is advanced, things have become connected through the Internet. Such a network environment or technology is generally called Internet of Things (IOT). In the IOT, things are connected using various networking methods to provide various services.

As the IOT technology is widely used, each IOT device is connected to a smartphone or a server through the networking technology. The IOT device may transmit a variety of types of sensing data to the smartphone or the server, may receive control data from the smartphone or the server, and may perform its operation based on the received control data.

In general, a smartphone includes a dedicated app for controlling a specific IOT device and controls the specific IOT device through a local area or wide area network.

If multiple IOT devices to be controlled are present, a smartphone may include multiple apps for the IOT devices and control the corresponding IOT devices. As described above, the smartphone requires multiple app programs for respective IOT devices.

Control of multiple IOT devices using a single app program may be assumed. In this case, it is necessary to easily specify or designate each IOT device.

As IOT devices are widely used, an embedded development kit for easily configuring an IOT device has been known. For example, an Arduino kit (or board) is equipped with a variety of types of sensors, input terminals, and output terminals. The Arduino kit has an input terminal connected to a given input signal, and may control a specific output terminal in response to the input signal. As described above, a programmable kit, such as the Arduino kit, is connected to a given input terminal and may control a given output terminal.

A development board, such as the Arduino kit, may configure an IOT device. In this case, the IOT device may be designated to perform various functions in various environments. The IOT device needs to be specified by a smartphone and to be controlled by the smartphone.

In order to solve a problem in control of the existing IOT device, there are needs for a method of controlling an IOT device using a cloud platform, a cloud server and a system for controlling an IOT device.

### PRIOR ART DOCUMENT

[Patent Document]

(Patent Document 1) 10-1792142 (B1), Nov. 20, 2017

### SUMMARY OF THE INVENTION

An embodiment of the present invention provides a method of controlling an IOT device using a cloud platform, a cloud server and a system for controlling an IOT device, wherein a mobile terminal recognizes an IOT device and dynamically provides a state and control interface corresponding to the recognized IOT device.

Furthermore, an embodiment of the present invention provides a method of controlling an IOT device using a cloud platform, a cloud server and a system for controlling an IOT device, wherein an IOT device is specified based on the recognition of an image code marked in the IOT device, a state image and control image corresponding to the specified IOT device are displayed in a mobile terminal, and based on the reception of an input for a control image the specified IOT device is controlled through a cloud server.

Furthermore, an embodiment of the present invention provides a method of controlling an IOT device using a cloud platform, a cloud server and a system for controlling an IOT device, wherein a state item and control item recognized in an IOT device are dynamically labeled, the state of the IOT device is identified by displaying the labeled state item and control item in a mobile terminal, and the IOT device is controlled so that the IOT device is applied and used in various environments.

Technical objects of the present invention are not limited to the above-described technical objects, and other technical objects not described above may be evidently understood by those skilled in the art to which the present invention pertains from the following description.

In an aspect of the present invention, a method of controlling an Internet of Thing (IOT) device includes receiving, by a cloud server, a device identifier (ID) extracted from an image code recognized by a mobile terminal, determining, by the cloud server, an IOT device corresponding to the received device ID among a plurality of IOT devices capable of being connected to a wide area network, recognizing, by the cloud server, one or more state items and one or more control items corresponding to the determined IOT device, and transmitting, by the cloud server, state information including one or more state items of the determined IOT device and control state information including one or more control items capable of controlling the determined IOT device and indicative of a current control state to the mobile terminal. The number of the recognized one or more state items and the recognized one or more control items are different each other depending on the determined IOT device.

In the method of controlling an IOT device, the image code is a quick response (QR) code. The device ID is a MAC address. One or more state icon images corresponding to the one or more state items of the state information and one or more control icon images corresponding to the one or more control items of the control state information overlap an image captured by the mobile terminal, and they are displayed.

The method of controlling an IOT device further includes receiving, by the cloud server, a labeling registration request for labeling a state item and a control item from the mobile terminal, and configuring, by the cloud server, the name of the state item of the determined IOT device as a labeling state name of the labeling registration request and configuring the name of the control item of the determined IOT device as a labeling control name of the labeling registration request. The state information includes the labeling state name of the state item, the control state information includes the labeling control name of the control item, and the state information including the labeling state name and the control state information including the labeling control name are displayed on a display of the mobile terminal.

The method of controlling an IOT device further includes receiving, by the cloud server, state data corresponding to the state item from each of the plurality of IOT devices to which the cloud server is connected and configuring, by the cloud server, each of the received state data in a state item of a device object of the IOT device. The state information transmitted to the mobile terminal includes a state item changed using the state data from the IOT device.

The method of controlling an IOT device further includes receiving, by the cloud server, a control request including a control item ID and control data from the mobile terminal, transmitting, by the cloud server, a device control request, corresponding to the control data, to an IOT device connected to the mobile terminal, and changing a control item of a device object of the IOT device in response to a control response received from the IOT device. The control state information transmitted to the mobile terminal includes a control item changed according to a response from the IOT device.

In the method of controlling an IOT device, the control item of the control state information includes control type data capable of specifying a control range. The control data included in the control request is determined from an input for a control icon image differently displayed in the mobile terminal for each control type within a control range configurable based on a control type.

Furthermore, in an aspect of the present invention, a cloud server includes a communication unit configured to transmit and receive data over a wide area network, a storage unit configured to store a plurality of device objects corresponding to a plurality of Internet of Things (IOT) devices capable of being connected through the wide area network, and a control unit configured to receive a device identifier (ID) extracted from an image code recognized by a mobile terminal over the communication unit, determine an IOT device corresponding to the received device ID using the plurality of device objects, and recognize one or more state items and one or more control items corresponding to the determined IOT device. The control unit configures state information including the one or more state items of the determined IOT device and control state information including the one or more control items capable of controlling the determined IOT device and indicative of a current control state, and transmits the state information and the control state information to the mobile terminal through the communication unit. The number of recognized one or more state items and recognized one or more control items are different each other depending on the determined IOT device.

In the cloud server, the control unit is configured to receive a labeling registration request for labeling a state item and a control item from the mobile terminal through the communication unit, configure the name of a state item of a device object, corresponding to the determined IOT device, as a labeling state name of the labeling registration request, and configure the name of the control item as a labeling control name of the labeling registration request. The state information includes the labeling state name of the state item, the control state information includes the labeling control name of the control item, and the state information including the labeling state name and the control state information including the labeling control name are displayed on the display of the mobile terminal.

Furthermore, in an aspect of the present invention, a system for controlling an Internet of Things (IOT) device includes the cloud server and a plurality of IOT devices connected to the cloud server over a wide area network. The control unit of the cloud server is configured to receive a control request, including a control item identifier (ID) and control data, from the mobile terminal through the communication unit, transmit a device control request, corresponding to the control data, to a connected IOT device among the plurality of IOT devices based on the device ID received from the mobile terminal through the communication unit, and change a control item of a device object of the IOT device according to a control response received from the IOT device through the communication unit. The control state information transmitted to the mobile terminal comprises a control item changed according to a response from the IOT device.

In the system for controlling an IOT device, the control item of the control state information includes control type data capable of specifying a control range. The control data included in the control request is determined from an input for a control icon image differently displayed in the mobile terminal for each control type within a control range configurable based on a control type.

### BRIEF DESCRIPTION OF THE DRAWINGS

FIG. 1 is a diagram showing an illustrative system for controlling an IOT device using cloud platform according to an embodiment of the present invention.

FIG. 2 is a block diagram showing an illustrative configuration of a cloud server.

FIG. 3 is a diagram showing an illustrative flow of controlling an IOT device using the cloud platform.

FIG. 4 is a diagram showing an example of icon images displayed in a mobile terminal.

<Description of reference numerals>

| | |
|---|---|
| 100: IOT device | 101: image code |
| 200: cloud server | 201: communication unit |
| 203: storage unit | 205: control unit |
| 207: connection unit | 300: mobile terminal |
| 400: wide area network | |

### DETAILED DESCRIPTION

The above objects, characteristics, and merits will become more apparent from the following detailed description taken in conjunction with the accompanying drawings, and thus those skilled in the art to which the present invention pertains may readily implement the technical spirit of the present invention. Furthermore, in describing the present invention, a detailed description of a known art related to the present invention will be omitted if it is deemed to make the gist of the present invention unnecessarily vague. Embodiments according to the present invention are described in detail below with reference to the accompanying drawings.

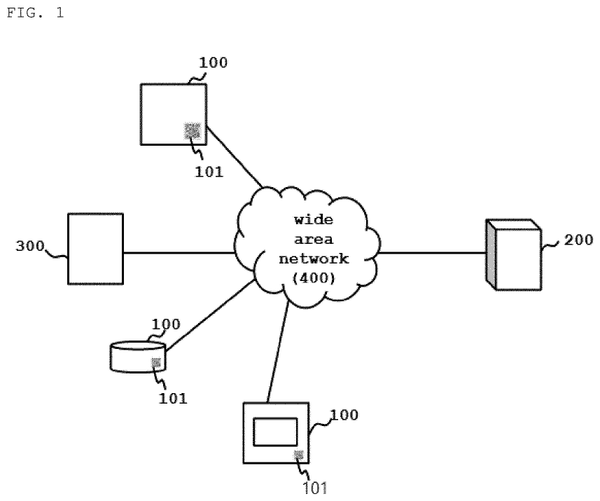

FIG. 1 is a diagram showing an illustrative system for controlling an IOT device using cloud platform according to an embodiment of the present invention.

Referring to FIG. 1, the system for controlling an IOT device includes one or more IOT devices 100, a mobile terminal 300, a cloud server 200 and a wide area network 400.

Devices (or apparatuses) configuring the system for controlling an IOT device are briefly described below. The IOT device 100 is a device that may be controlled over the wide area network 400, while operating in conjunction with the cloud server 200.

The IOT device 100 may be connected to a specific thing or may configure a specific thing and may collect required data at the specific thing or perform a variety of types of functions allocated thereto. The IOT device 100 may be connected to a given thing that requires networking or configure a given thing, such as home appliances, lights, furniture, and a variety of types of sensors.

The IOT device 100 is connected to the wide area network 400 through a network interface included in the IOT device 100, and may communicate with the cloud server 200. The IOT device 100 may be connected to the cloud server 200 over a local area or low power network, such as LoRa, NB-IOT, Zigbee, Bluetooth, a wireless LAN, or a wired LAN.

The IOT device 100 includes input ports and output ports. The IOT device may receive an input (e.g., state) signal through a given input port, may configure input (e.g., state) data corresponding to the received signal, and may transmit the input (e.g., state) data to the cloud server 200.

Furthermore, the IOT device 100 includes the output ports. The IOT device may receive a device control request from the cloud server 200, and may output a control signal, corresponding to the control data of the device control request, to an output port corresponding to the device control request.

Each of the IOT devices 100 may have different input ports and output ports because they perform different functions. Furthermore, functions or control mapped to the respective input ports and output ports may also be different.

Each IOT device 100 may be a dedicated device for performing a specific function or may be a device in which a standardized embedded board, such as a board for development, has been applied to a specific product or function. Accordingly, the number of used input/output ports, from among the input ports and output ports of a standardized embedded board, may be different each other depending on a function provided according to each device type or developer.

The IOT device 100 is configured to display an image code 101 on its outside. The IOT device 100 may embed the image code 101, such as a barcode or a quick response (QR) code displayed in an external casing or a chipset within an embedded board.

The image code 101, such as a barcode or a QR code, includes at least the device identifier (ID) of the IOT device 100. The device ID is used to identify (or distinguish between) an IOT device 100, corresponding to the device ID, from another IOT device 100 in the cloud server 200 at least. The device ID may be a MAC address or a serial number, for example.

For example, the image code 101 may be a QR code. The device ID of the IOT device 100 may be a MAC address of 32 bits, 48 bits or 128 bits, which is used in a local area or a low power network, such as LoRa, NB-IOT, Zigbee, Bluetooth, a wireless LAN, or a wired LAN. The image code 101 displayed in the IOT device 100 may be recognized by a camera of the mobile terminal 300.

The mobile terminal 300 is carried by a user in order to control the IOT device 100 in a system for controlling an IOT device using a cloud platform. The mobile terminal 300 may be a mobile phone, a smartphone, a tablet PC, or a notebook, for example.

The mobile terminal 300 includes a camera (or a camera sensor), a display, a communication interface that may be connected to the wide area network 400, a storage device (e.g., nonvolatile memory) for storing an app program, an input interface (e.g., a touch panel or a button) for receiving a user input, and an app processor. The mobile terminal may control a recognized IOT device 100 through the camera (or a camera sensor), while operating in conjunction with the cloud server 200.

For example, the mobile terminal 300 may recognize the image code 101 using the camera (or a camera sensor), and may extract a device ID from the image code 101. The mobile terminal 300 may transmit the extracted device ID to the cloud server 200 over the wide area network 400, may receive state information, corresponding to an input port of the recognized IOT device 100, and control state information of the output port of the recognized IOT device 100 from the cloud server 200, and may display them on the display.

The mobile terminal 300 may generate one or more state icon images from the state information, may generate one or more control icon images from the control state information, and may output (or display) the one or more state icon images and the one or more control icon images to the display by overlapping on an image captured by the camera.

The mobile terminal 300 includes an input interface, such as a touch panel and/or a button, and may control a specific output port of a recognized IOT device 100 through the cloud server 200 in response to a user input.

The cloud server 200 is connected to the IOT device(s) 100 over the wide area network 400, and is configured to remotely control the IOT device(s) 100 in response to a control request from the mobile terminal 300. The cloud server 200 is configured with one or more physical servers, and may control the IOT device(s) 100 through the mobile terminal 300 over the wide area network 400.

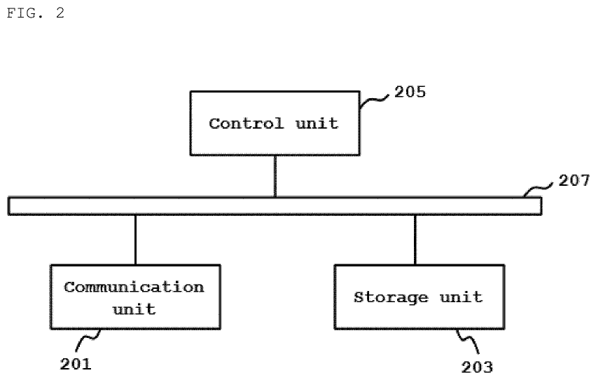

The configuration of the cloud server 200 and a control flow performed by the mobile terminal 300 and the IOT device 100 are specifically described with reference to FIG. 2 and below FIGs.

The wide area network 400 transmits and receives a variety of types of data between the IOT devices 100, the cloud server 200 and the mobile terminal 300. The wide area network 400 enables communication packets according to an agreed communication protocol to be transmitted and received between equipment, apparatuses, terminals or devices. The wide area network 400 may include a mobile communication network or Internet, or may be configured with a combination of them.

FIG. 2 is a block diagram showing an illustrative configuration of the cloud server 200.

Referring to FIG. 2, the cloud server 200 includes a communication unit 201, a storage unit 203, a control unit 205 and a connection unit 207. FIG. 2 shows a functional block diagram, and the function block is equipped with corresponding respective hardware block. For example, the cloud server 200 may be configured using a combination of one or more PCs, workstations and/or server frames.

The cloud server 200 may be logically recognized as a single server on the side of the IOT device 100 or the mobile terminal 300. However, the cloud server 200 may be configured with multiple servers as a physical structure or may be distributed on the Internet (e.g., the wide area network 400). Other blocks not shown in FIG. 2 may be further included in the block diagram of FIG. 2 depending on a design change.

The cloud server 200 is described below with reference to FIG. 2. The communication unit 201 transmits and receives data over the wide area network 400. The communication unit 201 may transmit and receive communication packets configured based on a designated communication protocol over the wide area network 400. The communication unit 201 is connected to the wide area network 400 through a wired LAN interface or wireless LAN interface included therein, and may transmit and receive communication packets including data, such as a variety of types of information, requests or responses.

The storage unit 203 stores a variety of types of data and programs. The storage unit 203 includes a volatile memory, a nonvolatile memory and/or a high-capacity storage medium such as a hard disk, and stores a variety of types of data and programs. The storage unit 203 may configure or include a database (DB) using one or more hard disks and/or nonvolatile memories.

A variety of types of data stored in the storage unit 203 is described below. The storage unit 203 stores an IOT-device management DB for managing the IOT devices 100. The IOT-device management DB stores device objects (or entries), which manage IOT devices 100 that may be controlled and managed in a system for controlling an IOT device and which correspond to the number of IOT devices 100 that may be managed over the wide area network 400.

Each of the device objects of the IOT-device management DB includes device ID information and user ID information, and further includes product type information, one or more state items and one or more control items.

The device ID information includes at least one ID of IOT device 100. For example, the device ID information includes the MAC address of a registered IOT device 100, and further includes an IP address and/or a telephone number capable of being connected to a mobile communication network or the Internet.

The user ID information includes at least one ID of mobile terminal 300. For example, the user ID information includes a user ID, a password, an IP address and/or a telephone number capable of being connected to a mobile communication network or the Internet.

The product type information indicates a product type of the IOT device 100. The product type information is an ID (i.e., product type ID) which may be configured by a developer or the distributor of the IOT device 100, and may indicate a specific product type on a standardized embedded board. For example, the product type information may be configured by a developer or a distributor. The number of inputs and outputs may be (differently) recognized depending on product type information.

The state item sets the current state of an available input port among input ports included in a registered IOT device 100. Each state item includes an input port ID, a state type and state data.

The input port ID is configured with a combination of numbers, characters and/or others by which a specific one of input ports included in the IOT device 100 can be identified. The state type indicates the type of data (e.g., binary data, unsigned or signed 8-bit data or unsigned or signed 16-bit data) which may be recognized through a corresponding input port. The state data indicates (input) data recognized through an input port based on a state type. The state data may be received from the IOT device 100 and stored. Furthermore, the state item further includes a labeling state name which may be labeled by a user, for example.

The control item sets the control state of an available output port among output ports included in a registered IOT device 100. Each control item includes an output port ID, a control type and control data.

The output port ID is configured with a combination of numbers, characters and/or others by which a specific one of output ports included in the IOT device 100 can be identified. The control type indicates the type of control data which may be output to a corresponding output port. The control type may indicate a binary type, a signed (or unsigned) 8-bit type or a signed (or unsigned) 16-bit type, for example. The control data indicates data that is set and output to the corresponding output port currently. The control data may be received from the IOT device 100 and identified, and may be configured and changed by the mobile terminal 300. Furthermore, the control item further includes a labeling control name which may be labeled by a user, for example.

In addition, the storage unit 203 may further include a product type information DB in which an input and output port for each product type is defined.

The product type information DB may include multiple product type items. The product type item stores a product type ID (e.g., the ID of product type information), a mapped input port and output port, and data related to each type.

The product type item may be configured by a developer, a distributor or a producer. For example, the product type item sets input ports and a type of the input port used by programming among available all input ports along with a product type ID and sets output ports and a type of the output port used by programming among available all output ports.

If the IOT device 100 is registered, a specific input and output port of several input and output ports of the IOT device 100 is used by a distributor or a designer based on corresponding product type information DB so that the input state of the IOT device 100 is monitored and an output thereof is changed.

The connection unit 207 transmits and receives data between the blocks of the cloud server 200. The connection unit 207 is configured using a local area network, a parallel bus and/or a serial bus.

The control unit 205 includes one or more execution units. The control unit loads a program stored in the storage unit 203, and controls the cloud server 200 by executing an instruction code of the program through the execution unit. The control unit 205 includes or indicates one or more processors, CPUs or MPUs.

The control unit 205 may load a control program stored in the storage unit 203, for controlling the IOT device 100, and may control the IOT device 100 recognized through the image code 101.

Furthermore, the control unit 205 receives a product type item registration request from a specific developer or a distributor using a control program, and generates a product type item in response to the received registration request so that the type of a corresponding IOT device 100 can be remotely controlled.

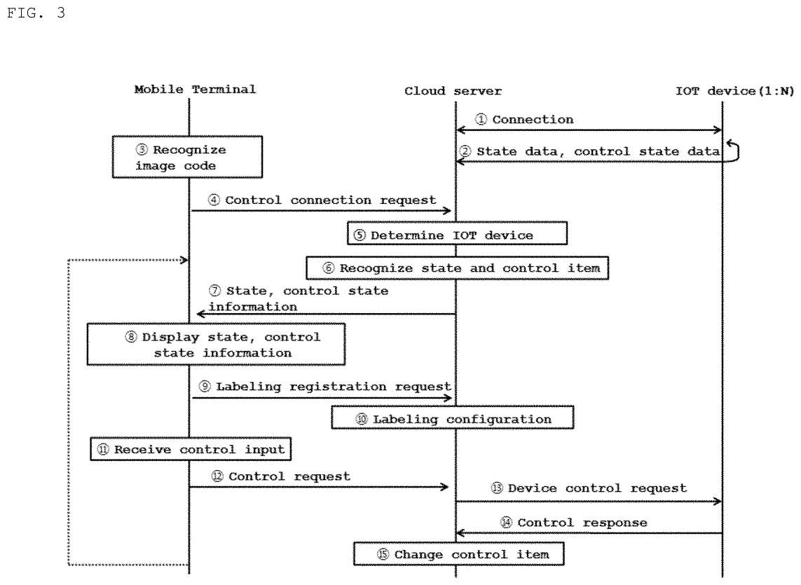

A variety of types of control performed in the control unit 205 is described below with reference to FIG. 3.

FIG. 3 is a diagram showing an illustrative flow of controlling the IOT device 100 using a cloud platform.

Prior to the progress of the flow of FIG. 3, a developer, a distributor or a manufacturer may register the product type of a distributed (or selling) IOT device 100 at the cloud server 200. For example, a developer may request generation of a product type item to the product type information DB of the cloud server 200, and may designate a product type ID, an input port and output port used by programming, and the type (e.g., binary or 8 bits) of each port in the product type item.

The registered IOT device 100 includes an embedded board. The embedded board may be included in a kit for development. A different IOT device 100 using the same embedded board as such a product type item is registered may use a different input port and output port based on different programming of a distributor or developer, and a user can control the corresponding input port and output port.

The registration of a product type item of the product type information DB may be omitted depending on a change in the design.

First, the control unit 205 (of the cloud server 200) establish a connection with the IOT device 100 that may be managed in a system for controlling an IOT device through the communication unit 201 (refer to \textcircled{1}).

For example, the control unit 205 (of the cloud server 200) extracts ID information of a given IOT device 100 (1:N, N is 2 or more), which may be extracted from a connection request, in response to a connection request from the IOT device 100, and determines whether the IOT device 100 can be connected based on device ID information of the device objects of the storage unit 203. If, as a result of the determination, it is determined that the IOT device 100 can be connected, the control unit 205 (of the cloud server 200) establishes a communication channel on the wide area network 400. The control unit 205 (of the cloud server 200) may transmit and receive communication packets, including a variety of types of data, to and from the IOT device 100 over the established communication channel.

The IOT device 100 connected to the cloud server 200 generates one or more state data and/or one or more control state data based on a set cycle or a change in input (or output) data, and transmits them to the cloud server 200 (refer to \textcircled{2}).

The transmission of the state data and the control state data from the IOT device 100 to the cloud server 200 is performed in accordance with a set cycle or a change in the data, and continues to be performed during, before or after a different control step.

Each of the state data may include data recognized in a corresponding input port along with an input port ID (e.g., input port number). Each of the control state data may include data, output to a corresponding output port, along with an output port ID (e.g., output port number). The recognized data and the output data may be data according to a set data type.

As the state data and/or the control state data are received from the IOT device 100 through the communication unit 201, the control unit 205 (of the cloud server 200) searches the storage unit 203 for a device object corresponding to the IOT device 100 that has transmitted the data.

For example, the control unit 205 (of the cloud server 200) may search for a device object corresponding to the device ID of a communication channel through which the state data and/or the control state data have been transmitted.

The control unit 205 (of the cloud server 200) configures each of the received state data in each of the state items of the retrieved device object, and configures each of the control state data in each of control items.

For example, the control unit 205 (of the cloud server 200) may search for a state item corresponding to the input port ID of the state data, may update the state data of the corresponding state item with the recognized data, may search for a control item corresponding to the output port ID of the control state data, and may update the control data of the corresponding control item with output data.

An example in which the control data is updated may be omitted or changed depending on an example of the design. For example, the control unit 205 (of the cloud server 200) may determine whether received output data is normal by comparing the received output data with the control data of a control item, and may omit the recording of the received output data in the device object of the output data.

The state item (or control item) updated or changed as described above may be configured as state information or control state information and transmitted to the mobile terminal 300. Accordingly, the mobile terminal 300 may identify a changed state or control output in the IOT device 100.

The mobile terminal 300 drives an app program for controlling the IOT device 100, and recognizes an image code 101 through the camera (refer to \textcircled{3}). The mobile terminal 300 recognizes the image code 101 in an image, captured by the camera, based on an agreed format, and extracts a device ID, configured based on an agreed format, from the image code 101. The mobile terminal 300 may further extract a product type ID depending on an example of the design. Preferably, the device ID may be the MAC address of the IOT device 100, and the image code 101 may be a QR code.

When the device ID corresponding to the image code 101 is first recognized, the mobile terminal 300 transmits a control connection request for controlling the recognized IOT device 100 to the cloud server 200 (refer to \textcircled{4}).

The control connection request includes at least a device ID, and may further include a product type ID. The control connection request may be configured with a single communication packet and transmitted or may be configured with multiple communication packets and transmitted. At least the cloud server 200 may receive the device ID from the mobile terminal 300, and may connect the mobile terminal 300 to an IOT device 100 corresponding to the received device ID.

As the device ID is received through the communication unit 201, the control unit 205 (of the cloud server 200) determines an IOT device among a plurality of IOT devices 100 capable of being connected to the wide area network 400 and that corresponds to the received device ID 100 (refer to \textcircled{5}).

For example, the control unit 205 (of the cloud server 200) searches the IOT-device management DB of the storage unit 203 for a device object (or entry) corresponding to the device ID (having the device ID).

If an IOT device 100 corresponding to the device ID is not determined because the device object is not retrieved, the control unit 205 (of the cloud server 200) may generate a new device object.

When the device object is not retrieved, the control unit 205 (of the cloud server 200) may newly configure device ID information, user ID information, product type information, and one or more state items and control items in a new device object, while operating in conjunction with the mobile terminal 300. The control unit 205 (of the cloud server 200) may first configure one or more state items and control items using a product type item corresponding to a product type ID in the product type information DB. The product type ID may be recognized through the image code 101.

When the IOT device 100 is determined in the IOT-device management DB, the control unit 205 (of the cloud server 200) recognizes one or more state items and one or more control items, corresponding to the determined IOT device 100, in the retrieved device object (refer to \textcircled{6}).

For example, the control unit 205 (of the cloud server 200) may extract one or more state items and one or more control items of the device object. The number of recognized one or more state items and one or more control items may be different for each type of the IOT device 100, and may be different although the IOT device 100 has a standardized embedded board.

The control unit 205 (of the cloud server 200) configures state information, including the data of the recognized one or more state items, and control state information, including the data of the recognized one or more control item indicative of the current control state. The control state information enables to control the determined IOT device 100. And the control unit 205 (of the cloud server 200) transmits the state information and the control state information to the mobile terminal 300 through the communication unit 201 (refer to \textcircled{7}).

Each of the state items of the state information includes a state type and current state data, and may further include a labeling state name or a state item ID (e.g., input port ID). Each of the control items of the control state information includes a control type and current control data, and may further include a labeling control name or a control item ID (e.g., output port ID).

The state item transmitted to the mobile terminal 300 does not need to be essentially the same as a state item stored in the device object, and may be data extracted or configured from a stored state item. The control item transmitted to the mobile terminal 300 does not need to be essentially the same as a control item stored in the device object, and may be data extracted or configured from a stored control item.

The transmission of the state information and the control state information to the mobile terminal 300 may be performed when a state or control state is changed or may be performed periodically or repeatedly in accordance with a set cycle.

The mobile terminal 300 receives the state information and the control state information from the cloud server 200, and displays the received state information and control state information on the display of the mobile terminal 300 (refer to \textcircled{8}).

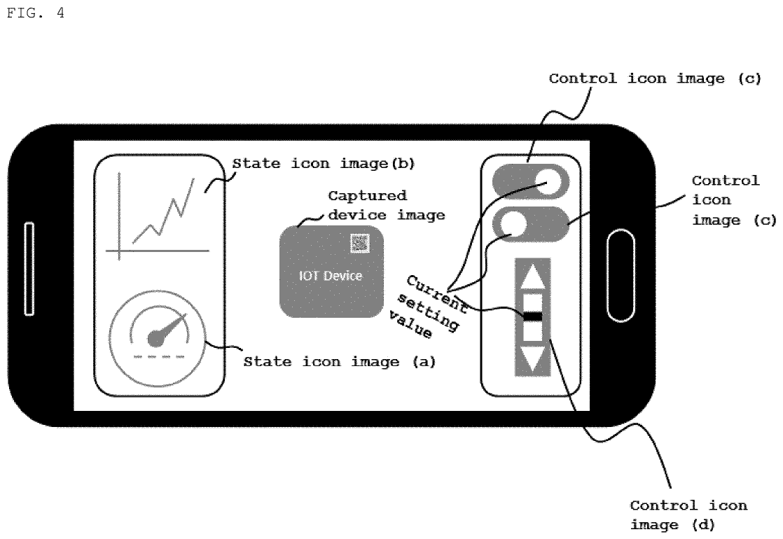

Specifically, the mobile terminal 300 configures each state icon image, corresponding to each of the state items of the received state information, using the state type and state data of the state item. The mobile terminal 300 configures a state icon image indicative of current state data within a data range that may be recognized based on the state type (or data type) of the state data (refer to (a) and (b) of FIG. 4). A specific state icon image may be configured by incorporating (or including) previous state data (refer to (b) of FIG. 4). A specific state icon image may be indicated within the entire range in which current received state data can be configured based on a data type (refer to (a) of FIG. 4).

Furthermore, the mobile terminal 300 configures each control icon image, corresponding to each of the control items of the control state information, using the control type and control data of the received control item. The control type included in the control state information may specify a control range. For example, if the control type is a binary type, corresponding control data may have a control value of 1 (On) or 0 (Off). If the control type is an 8-bit (16-bit) type, corresponding control data may have a control value up to 0˜255 (0˜65535).

The mobile terminal 300 configures a control icon image with respect to each control item based on each control type using current received control data. For example, the mobile terminal 300 configures a control icon image of a binary type as an On/Off button image (refer to © of FIG. 4). The mobile terminal 300 configures the control icon image of 8 bits, for example, in the form of a scale bar (e.g., an image icon whose current set value may be changed up and down or left or right) (refer to (d) of FIG. 4). The mobile terminal 300 is configured to indicate current configured control data (or control value) in each control icon image.

The mobile terminal 300 displays one or more state icon images, configured from the state information, and one or more control icon images, configured from the control state information, on the display. Each of the state icon images and each of the control icon images may overlap an image captured by the camera of the mobile terminal 300, and may be displayed on the display.

After a labeling name corresponding to each item is received, the mobile terminal 300 may display the labeling name by mapping the labeling name to a state icon image or a control icon image. Accordingly, the user of the mobile terminal 300 may precisely recognize the control target or usage of each image icon, and may identify a state according to the usage or perform required control.

The IOT device 100 according to an embodiment of the present invention may be configured by various developers, manufacturers or distributors and used for various purposes by users. Furthermore, the object or usage of input and output of the IOT device may be different for each user. Accordingly, a user may need to label each input or output port and to assign labeling to each input or output port.

The user of the mobile terminal 300 may label each state icon image and/or each control icon image with a name required by the user through an app program.

This is described specifically below. The user of the mobile terminal 300 inputs the labeling name of one or more state icon images or control icon images through an input interface. The mobile terminal 300 configures a labeling registration request including the input labeling name and transmits it to the cloud server 200 (refer to \textcircled{9}).

The labeling registration request includes a labeling state name along with the state item ID of a state item to be labeled and/or a labeling control name along with the control item ID of a labeled control item. The labeling state name and the labeling control name are data that is configured with a combination of numbers, characters and/or others and that are inputted by a user.

The control unit 205 (of the cloud server 200) receives the labeling registration request through the communication unit 201 over the wide area network 400 (refer to \textcircled{9}), configures the name of the state item of the device object of the determined IOT device 100 (refer to \textcircled{5}) as the labeling state name of the labeling registration request and/or configures the name of the control item as a labeling control name (refer to \textcircled{10}).

The control unit 205 (of the cloud server 200) may search the device object of the determined IOT device 100 for a state item whose configuration will be changed based on the state item ID of the labeling registration request, and may change the labeling state name of the corresponding state item. Furthermore, the control unit 205 (of the cloud server 200) may search the device object of the determined IOT device 100 for a control item whose configuration will be changed based on the control item ID of the labeling registration request, and may change the labeling control name of the corresponding control item.

After the labeling is changed, the state information and/or the control state information transmitted to the mobile terminal 300 are displayed on the display along with a state image icon and/or control icon image generated to include the labeling state name and/or labeling control name whose configuration has been changed.

The mobile terminal 300 receives a control input for a specific control icon image through an input interface (e.g., a touch panel combined with the display) (refer to \textcircled{11}). For example, a user may perform a control input for changing the On/Off configuration of an On/Off button image or changing a current set value in a scale bar. The mobile terminal 300 may receive the control input.

The mobile terminal 300 identifies a control item, corresponding to the control image icon whose control has been requested, in the control input, and determines control data for which control change will be requested based on the control type of the control item and the control input. Control data determined based on the control type may be different within a control range which may be configured based on the control type. Control data of a binary type may be a control value indicative of On (1) or Off (0). Control data of an 8-bit type may be a control value between 0 to 255. Each control datum is determined based on a user input for a corresponding control icon image.

The mobile terminal 300 configures a control request based on the user input, and transmits the control request to the cloud server 200 (refer to \textcircled{12}). The control unit 205 (of the cloud server 200) receives the control request through the communication unit 201. The control request transmitted to the cloud server 200 includes the control item ID whose control change will be performed and the control data to be changed.

The control unit 205 (of the cloud server 200) transmits, through the communication unit 201, a device control request to an IOT device 100 that belongs to the plurality of IOT devices 100 being managed in response to the control connection request and that is connected to the mobile terminal 300 based on the reception of the device ID through the image code 101 (refer to \textcircled{13}). For example, the cloud server 200 may configure the device control request, including the output port ID (control item ID) and the control data to be output to a corresponding output port, based on the received control request, and may transmit the device control request to the corresponding IOT device 100.

The IOT device 100 that has received the device control request over the wide area network 400 configures (set) an output port, corresponding to the output port ID, as the received control data (e.g., binary data, 8-bit data or 16-bit data). After the control data according to the configuration is output, the IOT device 100 may identify the configuration of the control data (e.g., may read the output data and determine whether the received control data is identical with the read output data by comparing the read output data with the received control data), may configure a control response including data, such as control change completion or control change impossible, and may transmit the control response to the cloud server 200.

The control unit 205 (of the cloud server 200) receives the control response, corresponding to the device control request, from the IOT device 100 (refer to \textcircled{14}), and changes (the control data of) a control item, corresponding to the control item ID (output port ID) of the device object of the IOT device 100, in response to the control response (refer to \textcircled{15}).

Thereafter, the control state information transmitted from the cloud server 200 to the mobile terminal 300 may include a control item changed in response to the control response from the IOT device 100.

The mobile terminal 300 connected to the IOT device 100 through the cloud server 200 may continue to receive state information or control state information periodically or in response to a change event (refer to \textcircled{7} and \textcircled{8}), and may change control of a specific output port based on the received information (refer to \textcircled{11} and \textcircled{12}).

Furthermore, each IOT device 100 may transmit state data or control state data periodically or in response to a change in the input (e.g., state) (refer to \textcircled{2}).

Various types of the IOT devices 100 can be controlled through the mobile terminal 300 based on the above-described control flow according to an embodiment of the present invention. Furthermore, in an embodiment of the present invention, the IOT devices 100 may be individually controlled by incorporating a modified configuration example of the IOT devices 100 using the same embedded board. Furthermore, in an embodiment of the present invention, control that may be displayed in the mobile terminal 300 and that is specific to each data type is made possible by incorporating the input and output data type of each IOT device 100.

As described above, the method of controlling an IOT device using a cloud platform, the cloud server and the system for controlling an IOT device according to an embodiment of the present invention have effects in that an IOT device can be recognized by a mobile terminal and a state and control interface corresponding to the recognized IOT device can be dynamically provided.

Furthermore, the method of controlling an IOT device using a cloud platform, the cloud server and the system for controlling an IOT device according to an embodiment of the present invention have effects in that an IOT device can be specified through the recognition of an image code displayed in the IOT device, a state image and control image corresponding to the specified IOT device can be displayed in a mobile terminal, and by receiving an input for the control image the specified IOT device can be controlled through the cloud server.

Furthermore, the method of controlling an IOT device using a cloud platform, the cloud server and the system for controlling an IOT device according to an embodiment of the present invention have an effect in that an IOT device can be applied and used for various environments by dynamically labeling a state item and control item recognized in the IOT device, displaying the labeled state item and control item in a mobile terminal, identifying the state of the IOT device, and controlling the IOT device.

Effects of the present invention are not limited to the above-described effects, and other technical effects not described above may be evidently understood by those skilled in the art to which the present invention pertains from the following description.

The present invention described above may be substituted, modified and changed by a person having ordinary skill in the art to which the present invention pertains without departing from the technical spirit of the present invention, and thus is not restricted by the above-described embodiments and the accompanying drawings.

What is claimed is:

1. A method of controlling an Internet of Thing (IOT) device, comprising:
receiving, by a cloud server, a device identifier (ID) extracted from an image code recognized by a mobile terminal;
determining, by the cloud server, an IOT device corresponding to the received device ID among a plurality of IOT devices capable of being connected to a wide area network and;
recognizing, by the cloud server, one or more state items and one or more control items corresponding to the determined IOT device; and
transmitting, by the cloud server, state information comprising one or more state items of the determined IOT device and control state information comprising one or more control items capable of controlling the determined IOT device and indicative of a current control state to the mobile terminal,
wherein a number of the recognized one or more state items and the recognized one or more control items are different each other depending on the determined IOT device.

2. The method of claim 1, wherein:
the image code is a quick response (QR) code,
the device ID is a MAC address, and
one or more state icon images corresponding to the one or more state items of the state information and one or more control icon images corresponding to the one or more control items of the control state information overlap an image captured by the mobile terminal and are displayed.

3. The method of claim 1, further comprising:
receiving, by the cloud server, a labeling registration request for labeling a state item and a control item from the mobile terminal; and
configuring, by the cloud server, a name of the state item of the determined IOT device as a labeling state name of the labeling registration request and configuring a name of the control item of the determined IOT device as a labeling control name of the labeling registration request,
wherein the state information comprises the labeling state name of the state item, the control state information comprises the labeling control name of the control item, and the state information comprising the labeling state name and the control state information comprising the labeling control name are displayed on a display of the mobile terminal.

4. The method of claim 1, further comprising:
receiving, by the cloud server, state data corresponding to the state item from each of the plurality of IOT devices to which the cloud server is connected; and
configuring, by the cloud server, each of the received state data in a state item of a device object of the IOT device,
wherein the state information transmitted to the mobile terminal comprises a state item changed using the state data from the IOT device.

5. The method of claim 1, further comprising:
receiving, by the cloud server, a control request comprising a control item ID and control data from the mobile terminal;
transmitting, by the cloud server, a device control request, corresponding to the control data, to an IOT device connected to the mobile terminal; and
changing a control item of a device object of the IOT device in response to a control response received from the IOT device,
wherein the control state information transmitted to the mobile terminal comprises a control item changed according to a response from the IOT device.

6. The method of claim 5, wherein:
the control item of the control state information comprises control type data capable of specifying a control range, and
the control data included in the control request is determined from an input for a control icon image differently displayed in the mobile terminal for each control type within a control range configurable based on a control type.

7. A cloud server, comprising:
a communication unit configured to transmit and receive data over a wide area network;
a storage unit configured to store a plurality of device objects corresponding to a plurality of Internet of Things (IOT) devices capable of being connected through the wide area network; and
a control unit configured to receive a device identifier (ID) extracted from an image code recognized by a mobile terminal over the communication unit, determine an IOT device corresponding to the received device ID using the plurality of device objects, and recognize one or more state items and one or more control items corresponding to the determined IOT device,
wherein the control unit configures state information comprising the one or more state items of the determined IOT device and control state information comprising the one or more control items capable of controlling the determined IOT device and indicative of a current control state, and transmits the state information and the control state information to the mobile terminal through the communication unit, and
a number of the recognized one or more state items and the recognized one or more control items are different each other depending on the determined IOT device.

8. The cloud server of claim 7, wherein:
the control unit is configured to receive a labeling registration request for labeling a state item and a control item from the mobile terminal through the communication unit, configure a name of a state item of a device object, corresponding to the determined IOT device, as a labeling state name of the labeling registration request, and configure a name of the control item as a labeling control name of the labeling registration request, and
wherein the state information comprises the labeling state name of the state item, the control state information comprises the labeling control name of the control item, and the state information comprising the labeling state name and the control state information comprising the labeling control name are displayed on a display of the mobile terminal.

9. A system for controlling an Internet of Things (IOT) device, comprising:
a cloud server of claim 7; and
a plurality of IOT devices connected to the cloud server over a wide area network,
wherein the control unit of the cloud server is configured to:
receive a control request, comprising a control item identifier (ID) and control data, from the mobile terminal through the communication unit,
transmit a device control request, corresponding to the control data, to a connected IOT device among the plurality of IOT devices based on the device ID received from the mobile terminal through the communication unit, and change a control item of a device object of the IOT device according to a control response received from the IOT device through the communication unit, and
wherein the control state information transmitted to the mobile terminal comprises a control item changed according to a response from the IOT device.

10. The system of claim 9, wherein:
the control item of the control state information comprises control type data capable of specifying a control range, and
the control data included in the control request is determined from an input for a control icon image differently displayed in the mobile terminal for each control type within a control range configurable based on a control type.
